(19) United States
(12) Patent Application Publication
(10) Pub. No.: US 2010/0010245 A1
(43) Pub. Date: Jan. 14, 2010

(54) RESINS OF NATURAL ORIGIN DERIVED FROM VEGETABLE OIL AND FROM HYDROXY ACIDS

(75) Inventors: Christine DENEUVILLERS, Maurepas (FR); Antoine PICCIRILLI, Poitiers (FR)

Correspondence Address: YOUNG & THOMPSON, 209 Madison Street, Suite 500, Alexandria, VA, 22314, US

(73) Assignees: COLAS, Boulogne-Billancourt (FR); VALAGRO, Poitiers (FR)

(21) Appl. No.: 12/488,282

(22) Filed: Jun. 19, 2009

(30) Foreign Application Priority Data
Jun. 20, 2008 (FR) 08 54108

(51) Int. Cl. C11C 3/00

(52) U.S. Cl. 554/115

(57) ABSTRACT

The present invention relates to an organic resin derived from a naturally occurring oil or fat comprising monoglycerides and/or diglycerides, esterified with a poly(hydroxy acid) having the following formula:

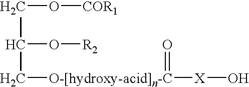

wherein R₁ is a saturated or unsaturated, aliphatic hydrocarbon chain comprising from 6 to 32 carbon atoms; R₂ is a hydrogen atom, a —COR₄ group, where R₄ is defined according to the same definition as R₁ or a poly(hydroxy acid) esterified group; the poly(hydroxy acid) group corresponding to [hydroxy acid]ₙ—CO—X—OH is a linear or a branched chain, obtained by condensating hydroxy acid monomers that are the same or different; depending on the nature of the hydroxy acid, X=—CH₂, —CHR, where R is an alkyl group having from 1 to 5 carbon atoms and comprising from 0 to 5 hydroxyl function(s); and n is the number of hydroxy acid units that are the same or different and does range from 3 to 2000.

The present invention relates to organic resins derived from a naturally occurring oil or fat. The present invention also relates to the method for making such resins. This invention relates to bioproducts made from renewable resources.

As used herein, a “bioproduct” means a product prepared from renewable raw materials, as opposed to raw materials of fossil origin like crude oil. Bioproducts may replace or improve other products composed of non renewable elements. Bioproducts are present in all the industrial sectors: plastics (food packaging), textiles (clothes and various fibers), detergents and hygienic products (household and body care products), inks (printing inks), cosmetics . . . .

These bioproducts have many advantages, but above all they are very interesting as to the environmental protection point of view. On the one hand, these products may replace raw materials of fossil origin. The crude oil resources are therefore preserved. On the other hand, biopolymers generally more easily degrade, which is not the case for the molecules constituting most of the crude oil-based plastics. Moreover, using such products enables the greenhouse gases to be reduced.

Naturally occurring product-containing resins are already commercially available. To be mentioned are especially vegetable oils, which did serve as raw materials for making semi-natural alkyd resins (plasticized polyesters). Such resins are obtained by condensating vegetable oils with petrochemical or synthetic origin anhydrides, such as maleic and phthalic anhydrides (A. Karleskind, Manuel des Corps Gras, pp 1461-1465).

Plastic resins have also been synthesized from vegetable oils and monomers such as styrene, cyclopentadiene and divinyl benzene, which are petrochemistry-derived compounds, by means of a cationic polymerization method.

Bio-polymers are also known, which are synthetically produced by reacting epoxidized soybean oil with acrylic acid or with maleic anhydride in the presence—or not, of synthetic polyols such as neopentyl glycol (NPG).

However, all these resins do not solely comprise raw materials of natural origin.

Research works have been conducted to develop new plastic materials of substantially natural origin.

These biopolymers made from renewable raw materials are typically polymers which either do naturally exist within living organisms or are synthesized by the latter from renewable resources. They thus may be:
of natural origin (treated plant extracts),
of microbial origin,
or be synthesized by living organisms, or
of animal origin.

These biopolymers are for example prepared from carbohydrates, lipids, proteins and polyphenols originating from plants, and especially from cellulose, starch, sugars, vegetable or animal oils, vegetable or animal proteins (HN Rabetafika and al., <<Les Polymers Issus du Végétal: Matériaux à Propriétés spécifiques pour des Applications Ciblees en Industries Plastique”, Biotechnol. Agron. Soc. Environn. 2006, 10 (3), pp 185-196).

These products include especially polylactic acid (PLA) derived from corn.

The European patent application EP 1 367 080 which discloses branched polymers from lactic acid and glycerin or from other plant polyols is to be mentioned as well.

However there is still a need for developing other biopolymers of natural origin, especially resins based upon renewable raw materials, that could replace in various applications petrochemical, synthetic or semi-natural resins, that are traditionally used.

These biopolymers should therefore be able to replace products consisting in non renewable components, such as raw materials of fossil origin, they also should be biofragmentable, biodegradable and with a low ecotoxicity. Moreover, these products should be preferably made from natural raw materials with no synthetic equivalent at a reasonable price. Amongst those compounds, natural resins with thermoplastic properties are especially appreciated.

As used herein, “a raw material and a compound of natural origin” means any product derived from the renewable, earth and sea biomass, or from living organisms (animals, microorganisms), or obtained through the action of microorganisms (for example enzymes, bacteria) on these compounds and natural raw materials according to biofermentation or biosynthesis methods.

As used herein, a “thermoplastic” material means a plastic material which melts when exposed to heat or, which does at least sufficiently soften to be formed indefinitely, without suffering from any change in its properties. More particularly, as used herein, a “thermoplastic property or behavior” in the context of the present invention, is intended to mean a resin which viscosity decreases as temperature increases (which makes it possible to easily handle the same at a relatively high temperature) and which retrieves its mechanical properties by the use temperatures.

The applicant discovered new resins of exclusively plant origin, having attractive thermoplastic properties enabling to use these resins in various applications.

The present invention therefore relates to organic resins derived from a naturally occurring oil or fat comprising monoglycerides and/or diglycerides, esterified with a poly(hydroxy acid) having the following formula:

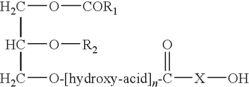

wherein,

R₁ is a saturated or unsaturated, aliphatic hydrocarbon chain comprising from 6 to 32 carbon atoms, optionally substituted with alkyl or hydroxyl groups,

R₂ is a hydrogen atom, a —COR₄ group, where R₄ is defined according to the same definition as R₁ or a poly(hydroxy acid) esterified group,

the poly(hydroxy acid) group corresponding to [hydroxy acid]ₙ—CO—X—OH is a linear or a branched chain, obtained by condensating hydroxy acid monomers that are the same or different,
depending on the nature of the hydroxy acid, X=—CH₂, —CHR, where R is an alkyl group having from 1 to 5 carbon atoms and comprising from 0 to 5 hydroxyl function(s),
n is the number of hydroxy acid units that are the same or different and ranges from 3 to 2000, preferably from 5 to 2000 and even better from 10 to 2000.

The resin of the invention has furthermore the following characteristics, to be considered either alone or in combination:
hydroxy acids are selected from α-hydroxylated acids such as lactic acid, citric acid, malic acid, tartaric acid, ascorbic acid and β-hydroxylated acids such as glycolic acid, salicylic acid, β-hydroxy butyric acid, preferably from lactic acid, citric acid and malic acid,
the number of hydroxy acid units, that are the same or different, ranges from 5 to 1000, preferably from 5 to 500, and more preferably from 5 to 120,
the number of hydroxy acid units, that are the same or different, ranges from 10 to 1000, preferably from 10 to 500, and more preferably from 10 to 120,
monoglycerides and/or diglycerides are derived from vegetable or animal oils selected from oleic and erucic rapeseed oils, linseed oil, sunflower seed oil, castor oil, Jatropha curcas oil, soyabean oil, palm oil, palm kernel oil, coconut oil, corn oil, cottonseed oil, groundnut oil, rice bran oil, olive oil, China wood oil, fish oils, micro- and macro-alga oils, tallow oil and tall oil,
vegetable oils comprise fatty acids having from 12 to 20 carbon atoms and preferably fatty acids having 18 carbon atoms,
the resin is mainly from natural origin, preferably from vegetable origin.

The present invention also relates to a method for preparing an organic resin derived from a naturally occurring oil or fat such as defined hereabove.

This method comprises a step (b) of reacting:
at least one hydroxy acid or one hydroxy acid ester in excess, or one already formed poly(hydroxy acid), with
a mono and/or a diglyceride.

The monoglyceride and/or diglyceride was or were previously obtained during a step (a), either:
by glycerolizing the triglycerides, or
by esterifying the glycerol with the fatty acids.

The preparation method of the invention has furthermore the following characteristics, to be considered either alone or in combination:
step (b) is carried out by reacting from 1 to 30% by weight, preferably from 1 to 20% by weight of monoglyceride and/or diglyceride with from 70 to 99% by weight, preferably with from 80 to 98% by weight as related to the total weight of the hydroxy acid resin or the already formed poly(hydroxy acid),
a catalyst is used in step (b) selected in the group consisting of tin, iron, zinc and aluminium organic salts, mineral or organic acids, basic catalysts, preferably the catalyst is a tin ethylhexanoate (SnOct₂),
step (b) is carried out according to a [hydroxy acid]/[number of acid+hydroxyl functions] mole ratio ranging from 3 to 1000, preferably from 5 to 500, and more preferably from 5 to 120.
step (b) is conducted at a temperature ranging from 100 to 220° C., preferably from 140 to 200° C.,
step (b) is from 5 to 12 hours long, preferably around 9 hours long.

The resins of the invention are derived from a naturally occurring oil or fat in that they are obtained from a monoglyceride or a diglyceride. These monoglycerides and diglycerides themselves are made from triglyceride which is the main component of vegetable oils and animal fats.

Indeed, vegetable oils are oils with high triglyceride contents or substantially composed of triglycerides of fatty acid ester and glycerol which fatty acids may be saturated or unsaturated, linear or branched, with from 6 to 32 carbon atoms and optionally from 0 to 10 unsaturation(s) and from 0 to 5 hydroxyl function(s) (—OH).

Vegetable oils to be suitably used in the present invention include oleic and erucic rapeseed oils, linseed oil, sunflower seed oil, castor oil, soyabean oil, palm oil, palm kernel oil, coconut oil, corn oil, cottonseed oil, groundnut oil, rice bran oil, olive oil, China wood oil, Jatropha curcas oil. Jatropha curcas oil extracted from the ripe Jatropha curcas seeds is an oil which is in liquid state at room temperature, of the unsaturated type and having a majority of oleic fatty acids (43-53%), linoleic fatty acids (20-32%) and palmitic fatty acids (13-15%).

Other natural triglyceride sources may also be used, such as fish oils, micro-alga and macro-alga oils, tallow oil and tall oil.

Oils will be preferably chosen which fatty acids comprise from 12 to 20 carbon atoms and more preferably C18-rich fatty acids such as oleic, linoleic or linolenic acid.

Hydroxy acids are organic acids characterized by at least one hydroxyl function (—OH) and at least one carboxylic function (—COOH). Natural hydroxy acids of the invention may comprise from 1 to 5 acid function(s) and from 1 to 6 hydroxyl functions in the alpha, beta, gamma and delta position of the acid function. α-hydroxyacids carry the hydroxyl function on the carbon adjacent to the carboxylic acid function (i.e. in position 1 of the acid function), while β-hydroxyacids carry the hydroxyl function on the second carbon adjacent to the carboxylic acid function (i.e. in position 2 of the acid function).

Natural hydroxy acids to be suitably used in the present invention include lactic acid (either in the D, L and racemic form), citric acid, malic acid, tartaric acid, glycolic acid, salicylic acid and β-hydroxybutyric acid. Lactic acid, citric acid or malic acid will be preferably used. Graft polyhydroxyacids thus belong to the group consisting of polylactate, polymalate, polyglycolate, polycitrate resulting from the condensation of the corresponding natural hydroxy acids.

The average molecular weight of an esterified poly(hydroxy acid) chain corresponding to the [hydroxy acid]ₙ—CO—X—OH group preferably ranges from 350 to 100 000 g.mol⁻¹, preferably from 350 to 20 000 g.mol⁻¹.

The resins of the invention are thus substantially of natural origin since they are prepared from naturally occurring oil or fat derivatives and natural hydroxy acids. According to the invention, as used herein, “substantially of natural origin” is intended to mean a resin which comprises, based on to the resin total weight, at least 95%, preferably at least 99% and more preferably 100% by weight of natural origin compounds.

The method for making the resins of the invention including the previous step of preparing the monoglycerides or diglycerides may be illustrated in the following way:

Step 1: Preparing a monoglyceride and diglyceride mixture:

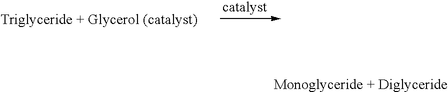

Step 2: Esterifying the monoglycerides and/or diglycerides using:
a) a hydroxy acid in excess:

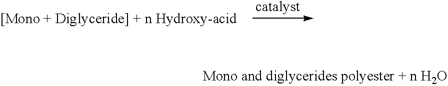

b) an already formed polyhydroxy acid

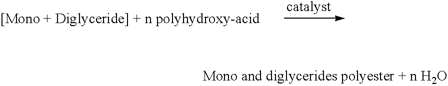

The resins of the invention thus correspond either to:
monoglycerides that have been monoesterified with a polymerized hydroxy acid,
monoglycerides that have been diesterified with a polymerized hydroxy acid, or
diglycerides that have been esterified with a polymerized hydroxy acid.

When the monoglyceride and/or the diglyceride is or are obtained by glycerolizing the triglycerides, the glycerol:oil molar ratio does range from 0.5 to 5. For obtaining a diglyceride-rich mixture, a glycerol:oil molar ranging from 0.9 to 1.1 is chosen. For obtaining a monoglyceride-rich mixture, a glycerol:oil molar ratio ranging from 1.9 to 2.1 is chosen.

The glycerol used is preferably a vegetable- or animal-originating one.

The catalyst that is used in step (a) of preparing mono and diglycerides by glycerolizing may be selected within the group consisting of basic, homogeneous and heterogeneous catalysts: NaOH, KOH, CaO, BaO, LiOH, Na₂CO₃, K₂CO₃, the rare earth oxides, les perovskytes, ZnO, ZnCl₂, SnCl₂ and lithium stearate. Transesterification acid catalysts may also be used such as acid resins, zeolites, alumina, HCl, H₂SO₄, paratoluene sulfonic acid. The basic catalyst NaOH will be preferably used.

This step is conducted at a temperature ranging from 60 to 280° C., preferably from 210 to 230° C.

In one embodiment of the present invention, monoglycerides and diglycerides may be prepared according to a method for esterifying glycerol with fatty acids according to the technique known from the person skilled in the art.

The catalyst of step (b) for activating the esterification reaction of the monoglycerides and diglycerides, as well as the condensation of the hydroxy acid with itself producing the polyester, is preferably selected in the group consisting of Sn, Fe, Zn, Al organic salts, inorganic or organic acids, and basic catalysts. Preferably, the catalyst is tin ethylhexanoate (SnOct2).

The mole ratio between the hydroxy acid and the number of acid+hydroxyl functions is ranging from 3 to 1000, preferably from 5 to 500, and more preferably from 5 to 120. The “number of acid+hydroxyl functions”, as used herein, does correspond in mole to the total number of reactive functions that are present in:
the monoglycerides; if so, it remains two hydroxyl functions that may react per monoglyceride, or in the diglycerides; and if so, it remains one hydroxyl function that may react per diglyceride,
in the fatty acid ester chains which may comprise one or more hydroxyl group(s).

By suitably selecting this mole ratio, the average length of the polyacid chains which will be graft onto each reactive function of the monoglyceride or diglyceride can be determined.

Step (b) is conducted at a temperature ranging from 100 to 220° C., preferably from 140 to 200° C.

The hydroxy acids used in step (b) may be in the ester form in order to carry out the esterification-condensation reaction according to a transesterification method for producing the poly(hydroxy acid) chain.

Lastly, in a further embodiment of the present invention (Step 2.b), the hydroxy acid condensation reaction may be conducted apart and thereafter the polyester formed may be reacted in step (b) from the previously prepared mixture of monoglycerides and diglycerides. In such a case, it is considered according to the invention that an already formed poly(hydroxy acid) is made to react.

The present invention will be illustrated by the following examples.

### EXAMPLE 1

### Preparing a Rapeseed Monooleate-Rich Lactic Resin

### Step a: Preparing a Rapeseed Monooleate-Rich Mixture

In a glass reactor provided with a mechanical stirring device, 392.2 g of oleic rapeseed oil, 67.6 g of glycerol and 3.3 g of 99% soda are combined. The mixture is heated to 220° C. and kept at this temperature for 2 hours. The triglyceride complete conversion is controlled through HPLC. At the end of the reaction, the mixture is gradually cooled down, prior to being stored.

Step b: Preparing a Natural Resin by Reacting Lactic Acid with a Rapeseed Monooleate-Rich Mixture

In a glass reactor provided with a mechanical stirring device and a Dean-Stark apparatus, the product obtained in step (a) (i.e. 463.1 g) is combined with 3101 g of 80% lactic acid and 28.8 g of 99% tin ethylhexanoate. The mixture is heated to 150° C. and kept at this temperature for 9 hours. At the end of the reaction, 2368 g are yielded of a resin having the following characteristics:
Acid index: 55
Iodine index: 15
Peroxide index: 82
Ash content: 0.50.

The product prepared according to the invention substantially has the following structure:

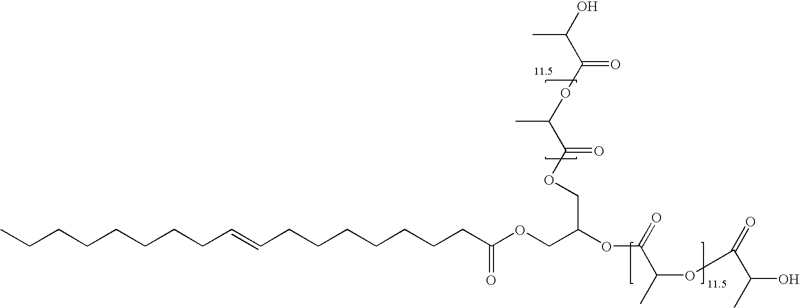

### EXAMPLE II

### Preparing a Castor Oil-Based Resin

### Step a: Preparing a Castor Monooleate-Rich Mixture

In a glass reactor provided with a mechanical stirring device, 287.9 g of castor oil, 42.2 g of glycerol and 2.1 g of 99% soda are combined. The mixture is heated to 220° C. and kept at this temperature for 2 hours. The triglyceride complete conversion is controlled through HPLC. At the end of the reaction, the mixture is gradually cooled down, prior to being stored.

Step b: Preparing a Natural Resin by Reacting Lactic Acid with a Castor Monooleate-Rich Mixture

In a glass reactor provided with a mechanical stirring device and a Dean-Stark apparatus, the product obtained in step a (i.e. 349.9 g) is combined with 3907.7 g of 80% lactic acid and 34.8 g of 99% tin ethylhexanoate. The mixture is heated to 150° C. and kept at this temperature for 9 hours. At the end of the reaction, 2773 g are yielded of a resin having the following characteristics:
Acid index: 68
Iodine index: 9
Peroxide index: 97
Ash content: 0.43

1. An organic resin derived from a naturally occurring oil or fat comprising monoglycerides and/or diglycerides, esterified with a poly(hydroxy acid) having the following formula: 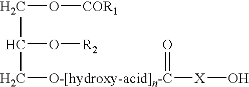
wherein,
R₁ is a saturated or unsaturated, aliphatic hydrocarbon chain comprising from 6 to 32 carbon atoms, optionally substituted with alkyl or hydroxyl groups,
R₂ is a hydrogen atom, a group —COR₄, where R₄ is defined according to the same definition as R₁ or a poly(hydroxy acid) esterified group,
the poly(hydroxy acid) group corresponding to [hydroxy acid]ₙ-CO—X—OH is a linear or a branched chain, obtained by condensating hydroxy acid monomers that are the same or different,
depending on the nature of the hydroxy acid, X=—CH₂, —CHR, where R is an alkyl group having from 1 to 5 carbon atoms and comprising from 0 to 5 hydroxyl function(s),
n corresponds to the number of hydroxy acid units that are the same or different and ranges from 3 to 2000.

2. A resin according to claim 1, wherein the hydroxy acids are selected from α-hydroxylated acids such as lactic acid, citric acid, malic acid, tartaric acid, ascorbic acid and β-hydroxylated acids such as glycolic acid, salicylic acid, β-hydroxy butyric acid, preferably from lactic acid, citric acid and malic acid.

3. A resin according to claim 1, wherein the number of hydroxy acid units that are the same or different does range from 5 to 1000, preferably from 5 to 500, and more preferably from 5 to 120.

4. A resin according to claim 1, wherein the monoglycerides and/or diglycerides are derived from vegetable or animal oils selected from oleic and erucic rapeseed oils, linseed oil, sunflower seed oil, castor oil, Jatropha curcas oil, sojabean oil, palm oil, palm kernel oil, coconut oil, corn oil, cottonseed oil, groundnut oil, rice bran oil, olive oil, China wood oil, fish oils, micro- and macro-alga oils, tallow oil and tall oil.

5. A resin according to claim 1, wherein the vegetable oil comprises fatty acids having from 12 to 20 carbon atoms and preferably fatty acids having 18 carbon atoms.

6. A resin according to claim 1, which is of substantially natural origin, preferably of vegetable origin.

7. A method for preparing an organic resin derived from a naturally occurring oil or fat, such as defined in claim 1, which comprises a step (b) of reacting:
at least one hydroxy acid or one hydroxy acid ester in excess, or one already formed poly(hydroxy acid), with
a mono and/or a diglyceride.

8. A preparation method according to claim 7, wherein step (b) is carried out by reacting from 1 to 30% by weight, preferably from 1 to 20% by weight of the monoglyceride and/or diglyceride with from 70 to 99% by weight, preferably with from 80 to 98% by weight as related to the total weight of the hydroxy acid resin or the already formed poly(hydroxy acid).

9. A preparation method according to claim 7, wherein a catalyst is used in step (b) selected in the group consisting of tin, iron, zinc, and aluminium organic salts, inorganic or organic acids, basic catalysts, preferably the catalyst is tin ethylhexanoate (SnOct₂).

10. A preparation method according to claim 7, wherein step (b) is conducted at a temperature ranging from 100 and 200° C., preferably from 140 to 160° C.

11. A preparation method according to claim 8, wherein a catalyst is used in step (b) selected in the group consisting of tin, iron, zinc, and aluminium organic salts, inorganic or organic acids, basic catalysts, preferably the catalyst is tin ethylhexanoate (SnOct₂).

12. A preparation method according to claim 8, wherein step (b) is conducted at a temperature ranging from 100 and 200° C., preferably from 140 to 160° C.

13. A resin according to claim 2, wherein the number of hydroxy acid units that are the same or different does range from 5 to 1000, preferably from 5 to 500, and more preferably from 5 to 120.
